(19) United States
(12) Patent Application Publication
(10) Pub. No.: US 2026/0363432 A1
(43) Pub. Date: Nov. 19, 2026

(54) MULTI-TOUCH MULTIMEDIA TABLE FOR CONTROL AND DECISION-MAKING ROOMS

(71) Applicant: TT GROUP S.R.L., ROMA (RM) (IT)

(72) Inventor: Fabrizio ROSSI, ROMA (RM) (IT)

(21) Appl. No.: 19/480,717

(22) PCT Filed: Jan. 22, 2024
(86) PCT No.: PCT/IB2024/050577

§ 371 Date: Oct. 31, 2025

(30) Foreign Application Priority Data
Jun. 9, 2023 (IT) 102023000011832

(51) Int. Cl. A47B 21/007; A47B 9/00; G06F 3/041

(52) U.S. Cl. CPC A47B 21/007; A47B 9/00; G06F 3/04146; G06F 3/04166; A47B 2021/0076

(57) ABSTRACT

Multi-touch multimedia table for control and decision-making rooms adapted to allow a clear and explicit communication between the interlocutors of any one company meeting, positioned around a multimedia table, which is adapted to show multimedia contents allowing an easy interaction between the interlocutors present and those in video call, using remote control over the WAN; said multimedia table being designed such that the people seated around it can comfortably reach the central touch area from any position, using a high-brightness LCD screen (11), for the purpose of showing high-quality images, also at extreme angles; the surface of the present table comprising a multi-touch transparent glass adapted to manage up to 40 simultaneous touches, recognizing the pressure of the fingers and the pressure exerted by the palm of the hand. The table comprises a support structure (12, 13), a side edge (17) to allow support for the interlocutors, and a plurality of joints (16), placed laterally to the upper surface (10) to allow stable connection between several multi-touch multimedia tables of the same type.

### FIELD OF THE ART

The invention refers to an innovative multi-touch table, adapted to allow the projection and the presentation of multimedia contents during company meetings, both for interlocutors who are physically present and for remote interlocutors; said multimedia table comprises the use of a multi-touch table which is further adjusted, in an automatic manner, with regard to the brightness of its screen, in order to optimize the viewing of the contents based on the light present in the room.

### PRIOR ART

The word “Meeting” is a term that derives from the English language and is employed in order to define an assembly where multiple people or collaborators meet, in order to discuss company strategies or simple topics of discussion.

The meetings are considered important events, in which only the people who received invitations can participate. For this reason, meetings take on particular importance in successful companies, where it is necessary to set strategies necessary for relaunching products on the market.

With the term meeting, also the following can be included: lessons (with presentation), seminars (generally numerous presentations, small public, only one day), conferences (of average size, one or more days), congresses (large size, various days), expos or fairs (with stands visited by people passing by).

In company meetings, in the current state of the art, it is difficult to maintain a stable channel of communication between the people who are physically present and those who are remotely connected by means of video call.

Indeed, it is often necessary to put up a presentation document together with the speech presented by several interlocutors of the meeting; such presentation, in order to be clearly visible to all the participants who are physically present, must be projected on a very large screen that can be viewed by all those present, accounting for the most accentuated angles that can create several blind points.

The presentations of slides are often employed in those meetings where all the participants are present. In such occasions, it has proven always necessary to arrange a wide monitor where all the participants can view the proposed multimedia contents.

At the current state of the art, there is no smart table present which can facilitate the display of multimedia contents for the participants of a meeting who are already seated around said table.

Not even patent CN217827158, published on 18 Nov. 2022, solves the abovementioned problems since it describes a smart school desk, capable of offering the student both the possibility of being supported for writing, and the possibility to be connected to the Internet in order to study new subjects; the patent CN217827158 in any case does not provide a sufficiently large and equipped table that can host a company meeting.

Therefore, the object of the patent is therefore that of claiming a multimedia system which comprises a multi-touch table adapted to allow all meeting participants to interact in real time with the shared multimedia contents, further facilitating the communication between those interlocutors who are not present in the same room.

### DESCRIPTION OF THE INVENTION

According to the present invention, a multi-touch multimedia table for control and decision-making rooms is attained which effectively resolves the abovementioned problems.

The present system comprises a multimedia table which is adapted to receive a plurality of collaborators, adapted to be consulted in order to decide strategies regarding the course of the company, using multimedia contents that can be advantageously managed by means of a touch-screen LCD screen installed above said table.

Said multimedia table is in fact designed such that the people seated around it can comfortably reach the central touch-screen area from any position, using the professional high-brightness LCD screen, with a sharp resolution of at least 3840×2160 pixels and extended vision angles, show high-quality images, even at extreme angles.

During a generic meeting, by using the remote control over the WAN, the interaction is facilitated between the interlocutors physically present and those in video call.

The present invention further employs multiple encryption keys, adapted to separate the communications in corporate environment, so as to create multiple encryption levels, achieving virtual VPN networks by means of a virtualization architecture.

The hardware composition of the multimedia table, object of the invention, comprises a horizontal support, adapted to provide a solid support base; said horizontal support comprises at least four adjustable feet adapted to compensate for possible unbalances of the flooring, conferring a high stability to the present table.

At least a vertical support is engaged above said horizontal support with a plurality of joints, and is able to give a height of at least 70 centimeters to the upper surface of the table, object of the invention, for the purpose of allowing a comfortable display of the multimedia contents both for the people seated around the table and for the people standing.

The vertical support at its interior comprises a plurality of known components adapted to allow the functioning of the professional high-brightness LCD screen; said vertical support is advantageously adapted to maintain the center of gravity of the table low, conferring greater stability to the multimedia table, object of the invention.

In one embodiment thereof, said vertical support is adapted to be extended or reduced by means of a telescopic mechanism, both electrically and manually operated; said vertical support can be adjusted in height for the purpose of optimizing the viewing of the multimedia contents by interlocutors of the company meeting, making their sessions around the table more comfortable.

By way of a non-limiting example, on the lateral walls of said vertical support and on the side edge of said upper surface, there is the application of the registered company logos and trademarks, by means of painting, on suitable marked spaces with a matte finish; said matte finish allows an easy removal of the painting if it is necessary to modify the logos.

In one embodiment thereof, said vertical support comprises a plurality of pockets adapted to house generic smartphones, allowing a wireless recharging of their battery during the company meeting.

Said upper surface, which is installed above said vertical support, comprises a multi-touch transparent glass, adapted to execute functions that are essential for company meetings, by employing a high-brightness LCD screen; a side edge of said upper surface, at least 10 centimeters wide, proves useful for allowing the support of objects during the functioning of the screen, without in any way hindering the viewing of the participants in the company meeting.

In one embodiment thereof, said upper surface is adapted to be tilted both in longitudinal and transverse sense, with respect to the vertical axis of the vertical support; said upper surface, once tilted due to a common joint, is adapted to facilitate the viewing of the multimedia contents for all the participants of the company meeting.

Below said upper surface, at least a power button is installed that is suitable for turning on or off said LCD screen; said button can be further pressed in order to carry out a reset of the entire system.

By way of a non-limiting example, a biometric detection sensor is installed inside said power button, so as to allow the access to specific contents only for the personnel in charge, increasing the security relative to the sensitive company information.

A high-performance controller based on one of the most recent Intel CPUs is installed below said vertical support, and is adapted to facilitate the image scrolling fluidity, further allowing a wireless connection a plurality of external devices.

Below said upper surface, a plurality of USB and HDMI ports are also installed, able to allow the reading and sharing of multimedia contents coming from peripheral devices, such as smartphones, tablets, or other similar devices; said USB ports have further proven suitable for recharging, by means of suitable cable, the devices of the people who participate at the aforesaid company meeting.

In order to allow the emission of the sounds belonging to the videos shown on said LCD screen, provision is made to install a plurality of loudspeakers, installed below said upper surface; said loudspeakers are adapted to allow the listening of the people involved in the video call.

The multimedia system, object of the invention, further comprises an audiovisual system such to comprise the innovative SDVoE technology, capable of replacing the traditional distribution system based on converter, matrix and videowall processor; said audiovisual system further comprises an SDVoE received in OPS format adapted to be inserted directly in suitable satellite screens connected with said table, allowing the display of the signals of the SDVoE network without having to use an external box.

Brightness sensors are included inside said upper surface, in its side edge, so as to detect the amount of light that hits the LCD screen of the present table, optimizing the brightness thereof; said sensors are therefore adapted to make the screen visible for all the participants of the meeting, regardless of their position around the table and regardless of the amount of light affecting the room where said company meeting is held.

Laterally to said upper surface, a plurality of joints are placed, adapted to allow a stable connection between multiple multi-touch multimedia tables of the same type; said joints advantageously facilitate the modulation of the multimedia tables, increasing the surface area usable for projecting images and viewing presentations during the company meetings; said joints are further suitable for synchronizing the plurality of tables joined together, associating them with the same energy source.

By way of a non-limiting example, a plurality of AUX ports are adapted to allow the use of special earphones, if the interlocutors of the company meeting prefer not to leak important information during the video calls.

In order to facilitate the connection of the table with a plurality of peripheral devices, in wireless mode, by way of example it is provided to install a Bluetooth connection module.

The multimedia table, object of the present multimedia system, in one embodiment thereof, is power supplied by a plurality of batteries, installed within said vertical support, so as to make the present multimedia table completely independent from the power line, in order to maintain its correct functioning even during possible sudden changes in current and voltage within the building.

The present multi-touch multimedia table comprises security modules adapted to execute a physical isolation of the data channel between optical fibers of different networks, by means of the use of a secure network isolator switch, in order to display data coming from unsafe or secret networks, from a single location, ensuring a waterproof isolation between networks.

In order to place the optical fibers of the output signal into correspondence with the optical fibers of the input signal, a mechanical movement is required, the signal in fact does not at any time pass through an electronic circuit, ensuring the privacy of the transmitted information.

By concatenating two switches, in fact, the signal is interrupted during the switching step.

In order to allow a more versatile display of the contents within the present multimedia system, a plurality of satellite screens and/or LED walls are able to interact with said table such to make the horizontal planes of the table interactable with the vertical planes of said screens; the information displayed on said table is thus further adapted to be moved onto the satellite screens and vice versa, without interruption, with the finger launching a window shown on the table, on one of the screens or satellite LED walls.

By way of a non-limiting example, in order to place said table in communication with any satellite screen, a direct optical fiber connection between a LED wall controller and the LED wall is employed; said LED wall controller proves to be characterized by copper outputs adapted to be inserted in the cabinets, with the purpose of obtaining a direct fiber connection in the cabinet, which can cover long distances with a 10 G or 40 G band, employing fewer cables.

Said LED wall controller further proves adapted to add different functions, such as Encryption AES256, for the purpose of making the LED wall more suitable for military applications.

By means of a multiplexing of signals 1 G, on a demux channel 10 G, the bidirectionality is ensured.

The advantages offered by the present invention are evident in light of the description set forth up to now, and will be even clearer from the enclosed figures and detailed description.

### DESCRIPTION OF THE FIGURES

The invention will be described hereinbelow in at least a preferred embodiment, given as a non-limiting example with the aid of the enclosed figures, in which:

FIG. 1 shows how two multi-touch multimedia tables can be associated in order to create a table with greater surface area. The present modulation thus allows receiving a greater number of participants in the company meeting. Such modulation is ensured by the presence of a plurality of joints 16, arranged laterally to a upper surface 10, suitable for synchronizing the LCD screens 11 useful for showing presentations and other multimedia contents. On the upper surface 10 of said table, around said LCD screen 11, a side edge 17 is made that is adapted to allow the support of a plurality of objects, without in any way hindering the visibility of the contents by the participants in the meeting. A plurality of brightness sensors 14 are adapted to adjust the brightness of said screen 11. The upper surface 10 is supported by a vertical support 12 and by a horizontal support 13.

FIG. 2 shows the table described in the present patent application, in a transverse view that has the purpose of showing the possibility to attain a telescopic vertical support 12, adapted to modify the height of the upper surface 10 depending on the needs of the participants in the meeting. Said telescopic vertical support 12 is always supported by a horizontal support 13; below said horizontal support 13, there is the application of at least four feet 18, adapted to compensate for possible irregularities of the flooring. Below said upper surface 10, a plurality of loudspeakers 20 are installed, adapted to allow people who are not physically present to listen, who therefore participate in the meeting by means of video call. A power button 19 is situated below the horizontal surface, and is adapted to turn said LCD screen 11 on and off.

### DETAILED DESCRIPTION OF THE INVENTION

The present invention will now be illustrated by way of a non-limiting or non-binding example, with reference to the figures which illustrate several embodiments relative to the present inventive concept.

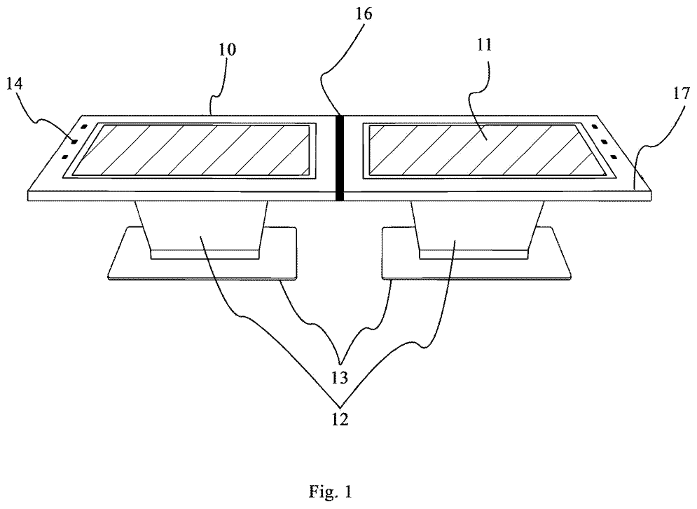

With reference to FIG. 1, two multimedia tables are illustrated that are coupled together, by using a plurality of joints 16 which are adapted to confer rigidity to the multimedia system obtained, synchronizing the above-installed LCD screens 11.

Said joints allow modulating the use of multimedia tables of the same type, so as to increase the surface usable for viewing digital presentations or possible reports during company meetings.

The brightness of the LCD screens 11, installed above said multimedia tables, is automatically adjusted by suitable brightness sensors 14, which are adapted to optimize the visibility of the contents shown through said screens 11.

The multimedia table presented in the present patent application comprises, on its upper surface 10, a side edge 17 of at least 10 centimeters, adapted to allow the support of objects without in any way reducing the visibility of the contents shown on the screens 11.

The upper surface 10 is supported by a vertical support 12, which is in turn supported by a horizontal surface 13.

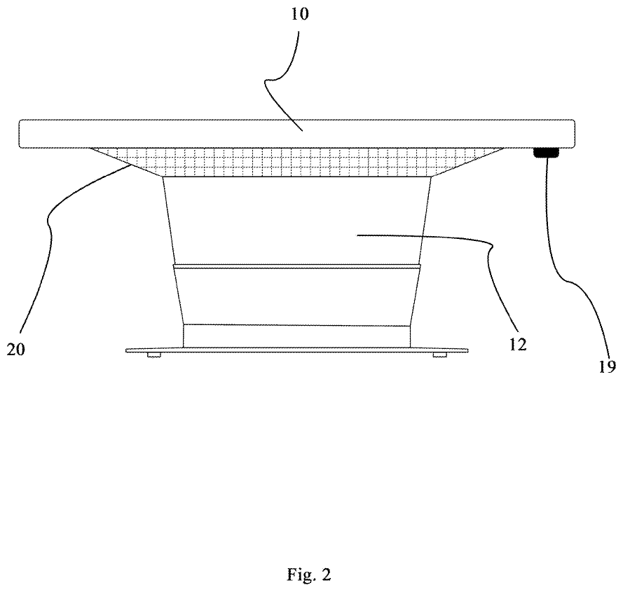

With reference to FIG. 2, one of the variants is illustrated which characterizes said multimedia table, more particularly the telescopic system is illustrated that is dedicated to the elongation of the vertical support 12.

Such vertical support 12, due to the telescopic system shown, is adapted to modify the height of the upper surface 10, facilitating the viewing of the digital contents by the participants of the company meeting.

The vertical support 12 is supported by the horizontal support 13, which employs at least four feet 18 in order to compensate for possible irregularities of the flooring, so as to confer stability to the present multimedia table.

Between said upper surface 10 and said vertical support 12, a plurality of loudspeakers 20 are included, adapted to facilitate the listening of the people who participate at the meeting by means of video call.

Below said upper surface 10, a power button 19 is installed that is useful for activating and deactivating said LCD screen 11, or advantageously adapted to carry out a reset of the entire system.

Finally, it is clear that modifications, additions or variations can be made to the invention described up to now that are obvious for the man skilled in the art, without departing from the protective scope that is provided with the enclosed claims.

1. Multi-touch multimedia table for control and decision-making rooms characterized in that it allows clear and explicit communication between the interlocutors of any company meeting, positioned around a multi-touch table, which is capable of displaying multimedia contents allowing easy interaction between the interlocutors present and those in the video call, taking advantage of remote control over the WAN; said multimedia table being designed in such a way that people seated around it can comfortably reach the central touch-screen area from any position, using a professional high-brightness LCD screen (11), with a sharp resolution of at least 3840×2160 pixels and extended vision angles, to show high-quality images, even at extreme angles; the present table comprising a multi-touch transparent glass able to manage up to 40 simultaneous touches, recognizing the pressure of the fingers and the pressure exerted by the palm of the hand; a side edge (17) of at least 10 centimeters in nanotechnological acrylic resin being able to allow a comfortable support for the interlocutors, exploiting a matte finish and soft to the touch; said multimedia table using multiple encryption keys to separate communications in a corporate environment so as to create multiple encryption levels, creating VPN virtual networks using a virtualization architecture; the present table being further able to communicate with any external monitor on the wall, in order to transfer the multimedia contents “launched” by sliding the finger on the multi-touch screen (11); said multi-touch multimedia table including:
at least a horizontal support (13), able to provide a solid support base for the multi-touch multimedia table; said horizontal support (13) comprising at least four adjustable feet (18) capable of compensating for any unbalances in the flooring, in order to confer high stability to the present multimedia table;
at least a vertical support (12), engaged above said horizontal support (13) with a plurality of joints, able to give a height of at least 70 centimeters to the upper surface (10) of the table, allowing a comfortable viewing of the multimedia contents by people sitting around the table and by people standing; said vertical support (12) comprising inside it a plurality of known components able to allow the operation of the high brightness professional LCD screen (11), included in the multimedia table in question; said vertical support (12) being able to maintain the center of gravity of the table low, giving greater stability to the multimedia table object of the present system;
at least an upper surface (10), installed above said vertical support (12), able to comprise a multi-touch transparent glass, which allows essential functions to be performed for company meetings, using said high brightness LCD screen (11); said upper surface (10) being characterized by a side edge (17) at least 10 centimeters wide, useful for allowing the support of objects during operation of the screen (11), without in any way hindering the vision of the participants in the company meeting;
at least a power button (19), located below said upper surface (10), suitable for turning on or off said LCD screen (11); said button (19) being further adapted to be pressed to carry out a reset of the entire system;
at least a high-performance controller based on one of the most recent Intel CPUs, installed inside said vertical support (12), capable of facilitating image scrolling fluidity, further allowing a wireless connection with a plurality of external devices;
a plurality of USB and HDMI ports, installed below said upper surface (10), able to allow the reading and sharing of multimedia contents coming from peripheral devices, such as smartphones, tablets, or other similar devices; said USB ports being further suitable for recharging, by means of a suitable cable, the devices of the people participating in the aforesaid company meeting;
a plurality of loudspeakers (20), installed below said upper surface (10), able to allow the emission of sounds belonging to the videos shown on said LCD screen (11); said loudspeakers (20) being further suitable for allowing the people involved in the video calls to be heard; the audiovisual system of the table which is the object of the invention further comprising SDVoE technology, capable of replacing the traditional distribution system based on a converter, matrix and videowall processor; said audiovisual system comprising an SDVoE receiver in OPS format able to be inserted directly into satellite screens connected with the present table, allowing the signals of the SDVoE network to be displayed without using an external box;
a plurality of brightness sensors (14), included inside said upper surface (10), in its side edge (17), suitable for detecting the amount of light that strikes the LCD screen (11) of the present table, optimizing its brightness; said sensors (14) therefore being capable of making said screen (11) easily visible by all participants in the meeting, regardless of their position around the table and regardless of the amount of light affecting the room where said company meeting is held;
a plurality of joints (16), placed laterally to said upper surface (10), able to allow a stable connection between several multi-touch multimedia tables of the same type; these joints (16) favoring the modulation of multimedia tables, increasing the usable surface for projecting images and viewing presentations during company meetings; said joints (16) being further suitable for synchronizing the plurality of tables joined together, associating them with a single energy source;
a plurality of security modules suitable for allowing physical isolation of the data channel between optical fibers of different networks, through the use of a secure network isolator switch, in order to display data coming from unsafe or secret networks on several levels, from a single location, ensuring waterproof isolation between networks; a mechanical movement being adapted to put the optical fibers of the output signal into correspondence with the optical fibers of the input signal, in fact the signal does not pass at any moment through an electronic circuit; concatenating two switches, the signal is interrupted during the switching phase;
a plurality of satellite screens and/or LED walls, able to interact with said table so as to make the horizontal planes of the table interact with the vertical planes of said screens; the information displayed on said table being further able to be moved to the satellite screens and vice versa, without interruption, by flipping a window shown on the table, on one of the satellite screens or LED walls, with the finger.

2. Multi-touch multimedia table for control and decision-making rooms, according to the preceding claim 1, characterized in that said vertical support (12), able to give a height of at least 70 centimeters to the upper surface (10), is able to be extended or reduced by a telescopic mechanism, both electrically and manually operated; said vertical support (12) can be adjusted in height in order to optimize the vision of the multimedia contents by the interlocutors of the company meeting, making their seats around the table more comfortable.

3. Multi-touch multimedia table for control and decision-making rooms, according to claim 1, characterized in that the lateral walls of said vertical support (12) and the lateral edge of said upper surface (10) comprise suitable marked spaces with a matte finish, designed to allow the company's registered logos and trademarks to be applied and removed, should it subsequently be necessary to modify these logos.

4. Multi-touch multimedia table for control and decision-making rooms, according to claim 1, characterized in that said upper surface (10), installed above said vertical support (12), is capable of being tilted both longitudinally and transversely, with respect to the vertical axis of the vertical support (12); said upper surface (10), once tilted thanks to a joint, is able to favor the viewing of the multimedia contents to all the participants of the company meeting.

5. Multi-touch multimedia table for control and decision-making rooms, according to claim 1, characterized in that a biometric detection sensor is installed inside said power button (19), in order to allow access to certain contents exclusively to the personnel in charge, increasing the security regarding the sensitive information of the company.

6. Multi-touch multimedia table for control and decision-making rooms, according to claim 1, characterized in that a plurality of AUX ports are able to allow the use of special earphones, if the interlocutors of the company meeting prefer not to leak important information during video calls.

7. Multi-touch multimedia table for control and decision-making rooms, according to claim 1, characterized in that it comprises a Bluetooth connection module suitable for facilitating connection with a plurality of peripheral devices, in wireless mode.

8. Multi-touch multimedia table for control and decision-making rooms, according to claim 1, characterized in that it comprises, laterally to said vertical support (12), a plurality of pockets suitable for housing generic smartphones, allowing for wireless recharging of their battery during the company meeting.

9. Multi-touch multimedia table for control and decision-making rooms, according to claim 1, characterized in that it is powered by a plurality of batteries, installed inside said vertical support (12), in order to make the present table multimedia completely independent from the power line, maintaining its correct functioning even during any sudden changes in current and voltage inside the building.

10. Multi-touch multimedia system for control and decision-making rooms, according to claim 1, characterized in that to put said table in communication with any satellite screen, a direct optical fiber connection is used between a LED wall controller and the LED wall; said LED wall controller being characterized by copper outputs to be inserted in the cabinets, with the aim of obtaining a direct fiber connection in the cabinet, in order to cover long distances with a 10 G or 40 G band, using fewer cables.
